(19) United States
(12) Patent Application Publication
(10) Pub. No.: US 2006/0033011 A1
(43) Pub. Date: Feb. 16, 2006

(54) Display device including sensing elements and driving method thereof

(76) Inventors: Young-Jun Choi, Suwon-si (KR); Kee-Han Uh, Yongin-si (KR); Joo-Hyung Lee, Gwacheon-si (KR); Jong-Woung Park, Seongnam-si (KR)

Correspondence Address: CANTOR COLBURN, LLP, 55 GRIFFIN ROAD SOUTH, BLOOMFIELD, CT, 06002, US

(21) Appl. No.: 11/195,322

(22) Filed: Aug. 2, 2005

(30) Foreign Application Priority Data
Aug. 2, 2004 (KR) 10-2004-0060954

(51) Int. Cl. G01J 1/42

(52) U.S. Cl. 250/208.2

(57) ABSTRACT

A method of detecting a two-dimensional position of a touch exerted on an information display panel is provided. The display panel includes a plurality of sensing elements. The two-dimensional position of the touch may be represented by first and second coordinates. The method includes determining a range for the first coordinate of the two-dimensional position by driving a first group of the sensing elements and determining the second coordinate of the two-dimensional position by driving a second group of the sensing elements, the second group of the sensing elements included in the first group of the sensing elements.

This application claims priority to Korean Patent Application No. 10-2004-0060954, filed Aug. 2, 2004 and all the benefits accruing therefrom under 35 U.S.C. §119, and the contents of which in its entirety are herein incorporated by reference.

### BACKGROUND OF THE INVENTION

(a) Field of the Invention

The present invention relates to a display device and a driving method thereof, and in particular, a display device including sensing elements and a driving method thereof.

(b) Description of Related Art

A liquid crystal display (LCD) device includes a pair of panels provided with pixel electrodes and a common electrode. The LCD device also includes a liquid crystal layer with dielectric anisotropy interposed between the panels. The pixel electrodes are arranged in a matrix and connected to switching elements such as thin film transistors (TFTs) such that the pixel electrodes receive image data voltages row by row. The common electrode covers an entire surface of one of the two panels and is supplied with a common voltage. A pixel electrode, corresponding portions of the common electrode, and corresponding portions of the liquid crystal layer form a liquid crystal capacitor. The liquid crystal capacitor as well as a switching element connected thereto constitutes a basic element of a pixel.

An LCD device generates electric fields by applying voltages to pixel electrodes and a common electrode. The LCD device varies the strength of the electric fields to adjust the transmittance of light passing through a liquid crystal layer, thereby displaying images.

Recently, LCD devices employing a sensor array has been developed. The sensor array generates electrical signals in response to a touch of a finger or a stylus, and the LCD device determines whether and where a touch exists based on the electrical signals. The LCD device sends the information on the touch to an external device that may return image signals to the LCD device, the image signals generated based on the information.

When the LCD device generates the information on the touch, it sequentially reads electrical signals from all the sensors in the sensor array, stores the signals into a memory, and applies a two-dimensional position detection algorithm. The two-dimensional position algorithm employs an image processing method, thereby determining whether and where a touch exists.

However, this method requires a high-speed digital signal processor (DSP) and a large-capacity buffer memory for timely extracting the touch information in a given frame period. Accordingly, the manufacturing cost increases, especially as the processing speed of the DSP and the size of the buffer memory increase. In addition, the increase of the resolution of the sensor array increases the data to be processed. As a result, the time for determining the touch position using a position detection algorithm also increases. The increase of the processing speed is a critical problem in applications such as handwriting recognition, which employ the above-described image processing method.

### SUMMARY OF THE INVENTION

In an exemplary embodiment, a method of detecting a two-dimensional position of a touch exerted on an information display panel is provided. The display panel includes a plurality of sensing elements. The two-dimensional position of the touch ise represented by first and second coordinates. The method includes determining a range for the first coordinate of the two-dimensional position by driving a first group of the sensing elements and determining the second coordinate of the two-dimensional position by driving a second group of the sensing elements, the second group of the sensing elements being included in the first group of the sensing elements.

In exemplary embodiments, the range for the first coordinate may be equivalent to the first coordinate. The driving of the first group of the sensing elements may include simultaneously driving the first group of the sensing elements. The second group of the sensing elements may be equivalent to the first group of the sensing elements, and the driving of the second group of the sensing elements may include sequentially driving the second group of the sensing elements.

The range for the first coordinate is wider than the first coordinate.

The method may further include determining the first coordinate from the range for the first coordinate.

In an exemplary embodiment, the first group of the sensing elements may include a third group of the sensing elements and a fourth group of the sensing elements, and the determination of the range for the first coordinate may include simultaneously driving the third group of the sensing elements to obtain first sensing data, simultaneously driving the fourth group of the sensing elements to obtain second sensing data and comparing the first sensing data and the second sensing data to determine the range for the first coordinate.

In another exemplary embodiment, the first group of the sensing elements may include a fifth group of the sensing elements and a sixth group of the sensing elements, where each of the fifth and the sixth groups may include parts of the sensing elements in the third and the fourth groups, and the determination of the range for the first coordinate may further include simultaneously driving the fifth group of the sensing elements to obtain third sensing data, simultaneously driving the sixth group of the sensing elements to obtain fourth sensing data, and comparing the third sensing data and the fourth sensing data to determine the range for the first coordinate.

The determination of the first coordinate may include reducing the range for the first coordinate by repeatedly driving a reduced number of the first group of the sensing elements.

In another exemplary embodiment, a method of detecting a two-dimensional position of a touch exerted on an information display panel is provided. The display panel includes a plurality of sensing elements. The method includes determining a range of a first coordinate and a range of a second coordinate of the two-dimensional position by driving a first number of the sensing elements and determining the first and the second coordinates of the two-dimensional position by driving a second number of the sensing elements, the second number being less than the first number.

The determination of the first and the second coordinates may include reducing the ranges for the first and the second coordinates by repeatedly driving a reduced number of the first number of the sensing elements.

In exemplary embodiments, methods of driving a display device according to the present invention are provided.

In exemplary embodiments, the display device includes a display panel and a touched position on the display panel is detected. The display panel includes a plurality of scanning lines, a plurality of data lines, and a plurality of sensing units coupled to the scanning lines and the data lines.

Another exemplary embodiment of a method includes simultaneously applying scanning signals to the scanning lines, generating first one-dimensional digital data based on output signals of the sensing units, extracting an x-coordinate of the touched position by applying a position detection algorithm to the first digital data, sequentially applying scanning signals to the scanning lines, sequentially reading sensing data signals from one of the data lines corresponding to the x-coordinate the data lines, generating second one-dimensional digital data based on the sensing data signals, and extracting a y-coordinate of the touched position by applying a position detection algorithm to the second digital data.

The simultaneous application of the scanning signals may apply all the scanning lines in the display panel.

The extraction of the x-coordinate may include determining whether a touch exists and extracting the x-coordinate when it is determined that a touch exists.

Another exemplary embodiment of method includes setting an entire area of the display panel as a sensing area, dividing the sensing area into first and second sub-areas assigned to different scanning lines, determining whether any one of the first and the second sub-areas is touched, extracting a y-coordinate of the touched position in the first sub-area when it is determined that the first sub-area is touched and extracting an x-coordinate of the touched position by applying a scanning signal to one of the scanning lines corresponding to the y-coordinate.

The extraction of the y-coordinate may include determining whether the first sub-area is divisible when it is determined that the first sub-area is touched, setting the first sub-area as a new sensing area to be divided into new first and second sub-areas when it is determined that the first sub-area is divisible and extracting a y-coordinate of the first sub-area as the y-coordinate of the touched position when it is determined that the first sub-area is indivisible.

The first and the second sub-areas may be substantially equivalent halves of the sensing area.

The determination of whether any one of the first and the second sub-areas is touched may include scanning the first sub-area to receive output signals from the sensing units in the first sub-area, generating first one-dimensional digital data based on the output signals of the sensing units in the first sub-area, scanning the second sub-area to receive output signals from the sensing units in the second sub-area generating second one-dimensional digital data based on the output signals of the sensing units in the second sub-area, and comparing the first digital data and the second digital data to determine whether any one of the first and the second sub-areas is touched.

The extraction of the x-coordinate may include applying a scanning signal to one of the scanning lines corresponding to the y-coordinate, generating third one-dimensional digital data based on output signals from the sensing units coupled to the one of the scanning lines, and applying a position detection algorithm to the third digital data to extract the x-coordinate of the touched position.

In another exemplary embodiment, the method may further include dividing the sensing area into third and fourth sub-areas different from the first and the second sub-areas and assigned to different scanning lines when it is determined that none of the first and the second sub-areas is touched, determining whether any one of the third and the fourth sub-areas is touched, and extracting a y-coordinate of the touched position in the third sub-area when it is determined that the third sub-area is touched.

The determination of whether any one of the third and the fourth sub-areas is touched may include scanning the third sub-area to receive output signals from the sensing units in the third sub-area, generating third one-dimensional digital data based on the output signals of the sensing units in the third sub-area, scanning the fourth sub-area to receive output signals from the sensing units in the fourth sub-area, generating fourth one-dimensional digital data based on the output signals of the sensing units in the fourth sub-area, and comparing the third digital data and the fourth digital data to determine whether any one of the third and the fourth sub-areas is touched.

Another exemplary embodiment of a method includes setting an entire area of the display panel as a sensing area; dividing the sensing area into a plurality of sub-areas assigned to different scanning lines and different data lines, determining whether any one of the sub-areas is touched, and extracting x and y coordinates of the touched position in one of the sub-areas when it is determined that the one of the sub-areas is touched.

The extraction of x and y coordinates may include determining whether the one of the sub-areas is divisible when it is determined that the one of the sub-areas is touched, setting the one of the sub-areas as a new sensing area to be divided into a plurality of new sub-areas when it is determined that the one of the sub-areas is divisible, and extracting x and y coordinates of the one of sub-areas as the x and y coordinates of the touched position when it is determined that the one of sub-areas is indivisible.

The sub-areas may be arranged in a matrix.

The determination of whether any one of the sub-areas is touched may include scanning each of the sub-areas to receive output signals from the sensing units therein, generating a digital data for each of the sub-areas based on the output signals of the sensing units in the sub-areas, and applying a position detection algorithm to the digital data to determine whether any one of the sub-areas is touched.

Exemplary embodiments of a display device according to the present invention include a display panel including a plurality of the scanning lines, a plurality of the data lines, a plurality of sensing units coupled to the scanning lines and the data lines, and a detection unit detecting a two-dimensional position of a touch exerted on the display panel and represented by first and second coordinates. The detection unit determines a range for the first coordinate of the two-dimensional position by applying scanning signals to a first group of the scanning lines, and determines the second coordinate of the two-dimensional position by applying scanning signals to a second group of the scanning lines included in the first group of the scanning lines.

The detection unit may include a scanning driver applying scanning signals simultaneously to at least two of the scanning lines, a sensing signal processor generating digital data based on output signals from the sensing units, and a signal controller dividing the display panel into a plurality of sub-areas and determining the first and the second coordinates based on the digital data for the sub-areas.

The detection unit may be integrated into a single chip.

The sensing units or the sensing elements may generate the output signals in response to incident light, pressure, like characteristics or any combination including at least one of the foregoing.

The display device may be selected from a liquid crystal display, an organic light emitting diode display, and a plasma display panel.

### BRIEF DESCRIPTION OF THE DRAWINGS

The present invention will become more apparent by describing embodiments thereof in detail with reference to the accompanying drawing in which:

FIG. 1 is a block diagram of an exemplary embodiment of an LCD device according to the present invention;

FIG. 2 is an equivalent circuit diagram of a pixel of an exemplary embodiment of an LCD device according to the present invention;

FIG. 3 is a flow chart illustrating an exemplary embodiment of a method of detecting a touched position according to the present invention;

FIG. 4 is a schematic diagram of an exemplary LCD device used to illustrate another exemplary embodiment of a method of detecting a touched position according to the present invention;

FIG. 5 is a flow chart illustrating the exemplary method related to FIG. 4;

FIG. 6 is a schematic diagram of an exemplary LCD device used to illustrate another exemplary embodiment of a method of detecting a touched position according to the present invention;

FIG. 7 is a flow chart illustrating the exemplary method related to FIG. 6;

FIG. 8 is a schematic diagram of an exemplary LCD device used to illustrate another exemplary embodiment of a method of detecting a touched position according to the present invention;

FIG. 9 is a flow chart illustrating the exemplary method related to FIG. 8.

### DETAILED DESCRIPTION OF THE INVENTION

The present invention now will be described more fully hereinafter with reference to the accompanying drawings, in which preferred embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

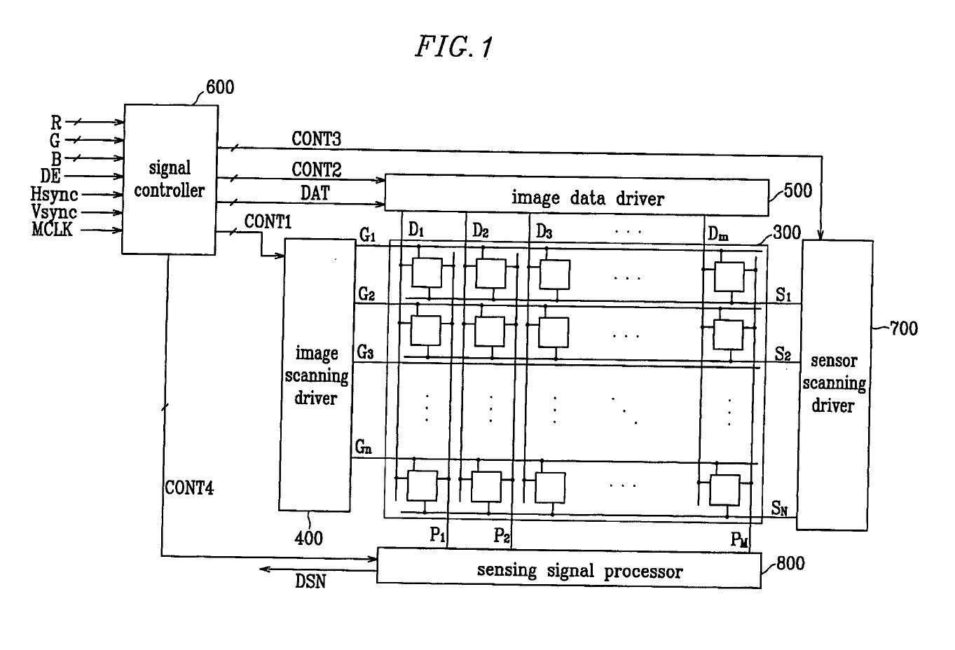

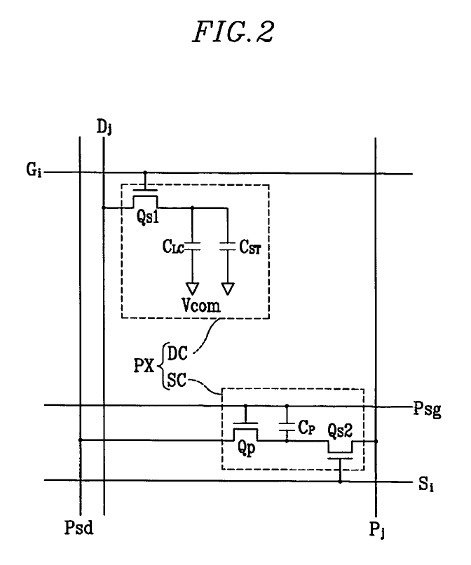

An exemplary embodiment of a liquid crystal display device according to the present invention now will be described in detail with reference to FIGS. 1 and 2.

FIG. 1 is a block diagram of an exemplary embodiment of an LCD device according to the present invention, and FIG. 2 is an equivalent circuit diagram of a pixel of an exemplary embodiment of an LCD device according to the present invention.

Referring to FIG. 1, an exemplary embodiment of an LCD device according to includes a liquid crystal (LC) panel assembly 300, an image scanning driver 400, an image data driver 500, a sensor scanning driver 700, and a sensing signal processor 800 that are coupled with the panel assembly 300. The LCD device also includes a signal controller 600 controlling the above elements.

Referring to FIGS. 1 and 2, the panel assembly 300 includes a plurality of display signal lines G₁-Gₙ and D₁-Dₘ and a plurality of sensor signal lines S₁-S_{N}, P₁-P_{M}, Psg and Psd. A plurality of pixels PX are connected to the display signal lines G₁-Gₙ and D₁-Dₘ and the sensor signal lines S₁-S_{N}, P₁-P_{M}, Psg and Psd. The display signal lines, sensor signal lines are arranged substantially in a matrix form as shown in FIG. 1.

The display signal lines include a plurality of image scanning lines G₁-Gₙ transmitting image scanning signals and a plurality of image data lines D₁-Dₘ transmitting image data signals.

The sensor signal lines include a plurality of sensor scanning lines S₁-S_{N} transmitting sensor scanning signals, a plurality of sensor data lines P₁-P_{M} transmitting sensor data signals, a plurality of control voltage lines Psg transmitting a sensor control voltage, and a plurality of input voltage lines Psd transmitting a sensor input voltage.

The image scanning lines G₁-Gₙ and the sensor scanning lines S₁-S_{N} extend substantially in a row direction and substantially parallel to each other, while the image data lines D₁-Dₘ and the sensor data lines P₁-P_{M} extend substantially in a column direction and substantially parallel to each other. In the exemplary embodiments of FIGS. 1 and 2, the image scanning lines G₁-Gₙ and the sensor scanning lines S₁-S_{N} extend in a direction substantially perpendicular to the image data lines D₁-Dₘ and the sensor data lines P₁-P_{M}, respectively.

Referring to FIG. 2, each pixel PX, for example, a pixel PX in the i-th row (i=1, 2, . . . , n) and the j-th column (j=1, 2, . . . , m), includes a display circuit DC connected to display signal lines Gᵢ and Dⱼ and a sensing circuit SC connected to sensor signal lines Sᵢ, Pⱼ, Psg and Psd. However, in alternative embodiments, only a portion of the pixels PX in the LCD device may include the sensing circuits SC. In other words, the concentration of the sensing circuits SC may be varied, thus varying the number N of the sensor scanning lines S₁-S_{N} and the number M of the sensor data lines P₁-P_{M}.

The display circuit DC includes a switching element Qs1 connected to an image scanning line Gᵢ and an image data line Dⱼ. The display circuit DC as shown in FIG. 2, includes an LC capacitor C_{LC} and a storage capacitor C_{ST} that are connected to the switching element Qs1. In alternative embodiments, the storage capacitor C_{ST} may be omitted.

The switching element Qs1 may include three terminals as shown in FIG. 2, i.e., a control terminal connected to the image scanning line Gᵢ, an input terminal connected to the image data line Dⱼ, and an output terminal connected to the LC capacitor C_{LC} and the storage capacitor C_{ST}.

The LC capacitor C_{LC} shown in FIG. 2 includes a pair of terminals and a liquid crystal layer (not shown) interposed therebetween. The LC capacitor C_{LC} is shown connected between the switching element Qs1 and a common voltage Vcom.

The storage capacitor C_{ST} assists the LC capacitor C_{LC} and it is connected between the switching element Qs1 and a predetermined voltage, such as the common voltage Vcom.

The sensing circuit SC includes a sensing element Qp connected to a control voltage line Psg and an input voltage line Psd, a sensor capacitor Cp connected to the sensing element Qp and a control voltage line Psg, and a switching element Qs2 connected to a sensor scanning line Sᵢ, the sensing element Qp, and a sensor data line Pⱼ.

The sensing element Qp has three terminals as shown in FIG. 2, i.e., a control terminal connected to the control voltage line Psg to be biased by the sensor control voltage, an input terminal connected to the input voltage line Psd to be biased by the sensor input voltage, and an output terminal connected to the switching element Qs2. The sensing element Qp may include a photoelectric material that generates a photocurrent upon receipt of light. An example of the sensing element Qp includes, but is not limited to, a thin film transistor having an amorphous silicon or polysilicon channel that can generate a photocurrent. The sensor control voltage applied to the control terminal of the sensing element Qp is sufficiently low or sufficiently high to keep the sensing element Qp in an off state without incident light. The sensor input voltage applied to the input terminal of the sensing element Qp is sufficiently high or sufficiently low to keep the photocurrent flowing in a direction. For example, in the exemplary embodiment shown in FIG. 2, the sensor input voltage applied may keep the photocurrent flowing toward the switching element Qs2 and into the sensor capacitor Cp to charge the sensor capacitor Cp.

The sensor capacitor Cp is connected between the control terminal and the output terminal of the sensing element Qp. The sensor capacitor Cp stores electrical charges output from the sensing element Qp to maintain a predetermined voltage.

The switching element Qs2 also has three terminals as shown in FIG. 2, i.e., a control terminal connected to the sensor scanning line Sᵢ, an input terminal connected to the output terminal of the sensing element Qp, and an output terminal connected to the sensor data line Pⱼ. The switching element Qs2 outputs a sensor output signal to the sensor data line Pⱼ in response to the sensor scanning signal from the sensor scanning line Sᵢ. In alternative embodiments, the sensor output signal may be a voltage stored in the sensor capacitor Cp or the sensing current from the sensing element Qp.

In other alternative embodiments, the switching elements Qs1 and Qs2, and the sensing element Qp, may include amorphous silicon or polysilicon thin film transistors (TFTs).

Additionally, in other embodiments, one or more polarizers (not shown) are provided at the panel assembly 300.

The image scanning driver 400 of the exemplary embodiment of FIG. 1, is shown connected to the image scanning lines G₁-Gₙ of the panel assembly 300 and synthesizes a gate-on voltage Von and a gate-off voltage Voff to generate the image scanning signals for application to the image scanning lines G₁-Gₙ.

The image data driver 500 of FIG. 1 is shown connected to the image data lines D₁-Dₘ of the panel assembly 300 and applies image data signals to the image data lines D₁-Dₘ.

The sensor scanning driver 700 is connected to the sensor scanning lines S₁-S_{N} of the panel assembly 300 and synthesizes a gate-on voltage Von and a gate-off voltage Voff to generate the sensor scanning signals for application to the sensor scanning lines S₁-S_{N}. In alternative embodiments, the sensor scanning driver 700 may apply the gate-on voltage Von to the sensor scanning lines S₁-Sₙ independently or simultaneously.

The sensing signal processor 800 as shown in the exemplary embodiment of FIG. 1, is connected to the sensor data lines P₁-P_{M} of the display panel 300 and receives and processes the analog sensor data signals from the sensor data lines P₁-P_{M}. One sensor data signal carried by one sensor data line P₁-P_{M} at a time may include one sensor output signal from one switching element Qs2 or, in alternative embodiments, may include at least two sensor output signals outputted from at least two switching elements Qs2.

The signal controller 600 as shown in FIG. 1, controls the image scanning driver 400, the image data driver 500, the sensor scanning driver 700, and the sensing signal processor 800, etc.

Each of the processing units 400, 500, 600, 700 and 800 may include at least one integrated circuit (IC) chip mounted on the LC panel assembly 300 or on a flexible printed circuit (FPC) film in a tape carrier package (TCP) type, which are attached to the panel assembly 300. Alternately, at least one of the processing units 400, 500, 600, 700 and 800 may be integrated into the panel assembly 300 along with the signal lines G₁-Gₙ, D₁-Dₘ, S₁-S_{N}, P₁-P_{M}, Psg and Psd, the switching elements Qs1 and Qs2, and the sensing elements Qp. Alternatively, all the processing units 400, 500, 600, 700 and 800 may be integrated into a single IC chip, but at least one of the processing units 400, 500, 600, 700 and 800 or at least one circuit element in at least one of the processing units 400, 500, 600, 700 and 800 may be disposed out of the single IC chip.

Now, the operation of the above-described exemplary LCD device will be described in detail.

In the exemplary embodiment of FIG. 1, the signal controller 600 is supplied with input image signals R, G and B and input control signals for controlling the display thereof from an external graphics controller (not shown). The input control signals may include, but are not limited to, a vertical synchronization signal Vsync, a horizontal synchronization signal Hsync, a main clock MCLK, and a data enable signal DE.

On the basis of the input control signals and the input image signals R, G and B, the signal controller 600 generates image scanning control signals CONT1, image data control signals CONT2, sensor scanning control signals CONT3, and sensor data control signals CONT4. The signal controller 600 also processes the image signals R, G and B suitable for the operation of the display panel 300. The signal controller 600 sends the scanning control signals CONT1 to the image scanning driver 400, the processed image signals DAT and the data control signals CONT2 to the data driver 500, the sensor scanning control signals CONT3 to the sensor scanning driver 700, and the sensor data control signals CONT4 to the sensing signal processor 800.

The image scanning control signals CONT1 may include an image scanning start signal STV for instructing to start image scanning and at least one clock signal for controlling the output time of the gate-on voltage Von. In alternative embodiments, the image scanning control signals CONT1 may include an output enable signal OE for defining the duration of the gate-on voltage Von.

The image data control signals CONT2 may include a horizontal synchronization start signal STH to start image data transmission for a group of pixels PX, a load signal LOAD to apply the image data signals to the image data lines D₁-Dₘ, and a data clock signal HCLK. In alternative embodiments, the image data control signal CONT2 may further include an inversion signal RVS for reversing the polarity of the image data signals (with respect to the common voltage Vcom).

Responsive to the image data control signals CONT2 from the signal controller 600, the data driver 500 receives a packet of the digital image signals DAT for the group of pixels PX from the signal controller 600, converts the digital image signals DAT into analog image data signals, and applies the analog image data signals to the image data lines D₁-Dₘ.

The image scanning driver 400 applies the gate-on voltage Von to an image scanning line G₁-Gₙ in response to the image scanning control signals CONT1 from the signal controller 600, thereby turning on the switching transistors Qs1 connected thereto. The image data signals applied to the image data lines D₁-Dₘ are then supplied to the display circuit DC of the pixels PX through the activated switching transistors Qs1.

The difference between the voltage of an image data signal and the common voltage Vcom across the LC capacitor C_{LC}, is referred to as a pixel voltage. The LC molecules in the LC capacitor C_{LC} have orientations depending on the magnitude of the pixel voltage. It is the molecular orientations that determine the polarization of light passing through an LC layer (not shown). The polarizer(s) converts the light polarization into the light transmittance to display images.

By repeating this procedure during a unit of a horizontal period (also referred to as “1H” and equal to one period of the horizontal synchronization signal Hsync and the data enable signal DE), all image scanning lines G₁-Gₙ are sequentially supplied with the gate-on voltage Von, thereby applying the image data signals to all pixels PX to display an image for a frame.

When the next frame starts after one frame finishes, the inversion control signal RVS applied to the data driver 500 is controlled such that the polarity of the image data signals is reversed (which is referred to as “frame inversion”). In alternative embodiments, the inversion control signal RVS may be also controlled such that the polarity of the respective image data signals flowing in a data line is periodically reversed during one frame (for example, row inversion and dot inversion), or the polarity of the respective image data signals in one packet is reversed (for example, column inversion and dot inversion).

The sensor scanning driver 700 applies the gate-off voltage to the sensor scanning lines S₁-S_{N} to turn on the switching elements Qs2 connected thereto in response to the sensing control signals CONT3. The switching elements Qs2 output sensor output signals to the sensor data lines P₁-P_{M} to form sensor data signals, and the sensor data signals are inputted into the sensing signal processor 800.

The sensing signal processor 800 amplifies or filters the read sensor data signals and converts the analog sensor data signals into digital sensor data signals DSN to be sent to the signal controller 600 in response to the sensor data control signals CONT4. The signal controller 600 appropriately processes signals from the sensing signal processor 800 to determine whether and where a touch exists. The signal controller 600 may send information about the touch to (external) devices that demand the information. In alternative embodiments, an external device may send image signals generated based on the information to the LCD device.

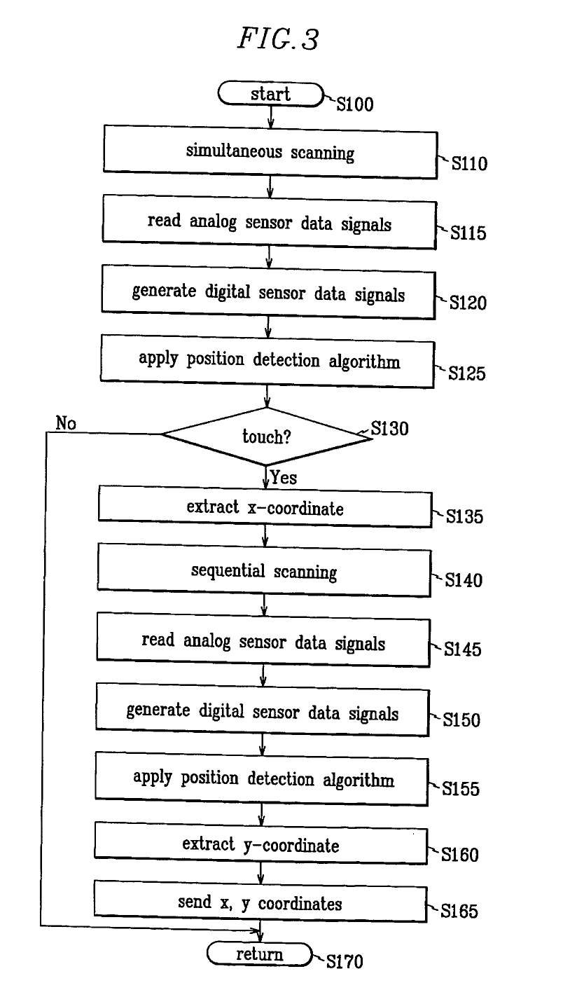

Now, exemplary embodiments of methods of detecting a touched position on the exemplary LCD device shown in FIGS. 1 and 2 will be described in detail with reference to FIGS. 3-9.

FIG. 3 is a flow chart illustrating an exemplary embodiment of a method of detecting a touched position according to the present invention.

When an operation starts (S100), the sensor scanning driver 700 simultaneously makes the voltage levels of sensor scanning signals Vs₁-Vs_{N} applied to respective sensor scanning lines S₁-S_{N}, equal to the gate-on voltage Von in response to the sensor scanning control signals CONT3 (S110). The switching elements Qs2 turn on to output sensor output signals from the sensing elements Qp to the sensor data lines P₁-P_{M}. The sensor output signals entered in each of the sensor data lines P₁-P_{M} join together to form an analog sensor data signals Vₚ_{₁}-Vₚ_{_{M}}.

The sensing signal processor 800 receives the analog sensor data signals Vp₁-Vp_{M} from the sensor data lines P₁-P_{M} (S115).

The sensing signal processor 800 amplifies and filters the analog sensor data signals Vp₁-Vp_{M} and converts them into digital sensor data signals x₁-x_{M} (S120) to be sent to the signal controller 600. The digital sensor data signals x₁-x_{M} may be, for example, one-dimensional data.

The signal controller 600 receives the digital sensor data signals x₁-x_{M} from the sensing signal processor 800 and applies one-dimensional position detection algorithm to the digital sensor data signals x₁-x_{M} (S125) to determine whether a touch exists (S130).

The one-dimensional position detection algorithm detects a minimum or a maximum of the one-dimensional data to find a touched position. An example of a position detection algorithm includes an edge detection algorithm that compares adjacent data to obtain a maximum or a minimum. Algorithms other than above-described example are also contemplated for finding a maximum or a minimum from one-dimensional data.

The process restarts (S170) when it is determined that no touch exists.

However, when it is determined that a touch exists, an x-coordinate PX of a touched position is extracted (S135).

Thereafter, the sensor scanning driver 700 sequentially makes the sensor scanning signals Vs₁-Vs_{N} equal to the gate-on voltage Von (S140). The switching elements Qs2 turn on row by row to output the sensor output signals transmitted to the sensing signal processor 800 as analog sensor data signals Vp₁-Vp_{M} through the sensor data lines P₁-P_{M}.

The sensing signal processor 800 receives the analog sensor data signals Vg₁-Vg_{N} from the sensor data lines P₁-P_{M} corresponding to the x-coordinate PX (S145). Here, a sensor data signal Vgᵢ denotes a sensor data signal for the i-th row.

The sensing signal processor 800 amplifies and filters the analog sensor data signals Vg₁-Vg_{N} and converts them into digital sensor data signals y₁-y_{N} (S150) to be sent to the signal controller 600. The digital sensor data signals y₁-y_{N} may be, for example, one-dimensional data.

The signal controller 600 receives the digital sensor data signals y₁-y_{N} and applies a one-dimensional position detection algorithm to the digital sensor data signals y₁-y_{N} (S155) to extract a y-coordinate PY of the touched position (S160).

The signal controller 600 sends the extracted x and y coordinates PX and PY to an external device (S165) and restarts the process (S170).

As described in the exemplary embodiment above, the x-coordinate of the touched position is firstly detected by simultaneous scanning and the y-coordinate of the touched position is then detected by sequential scanning. Advantageously, a one-dimensional position detection algorithm may be employed, effectively reducing the amount of data and the process time of the data.

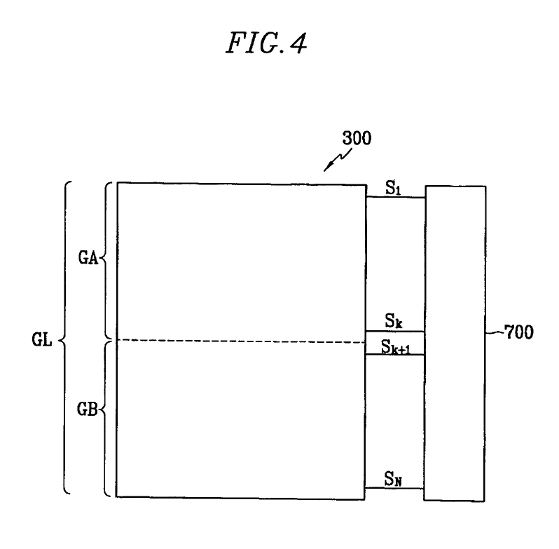

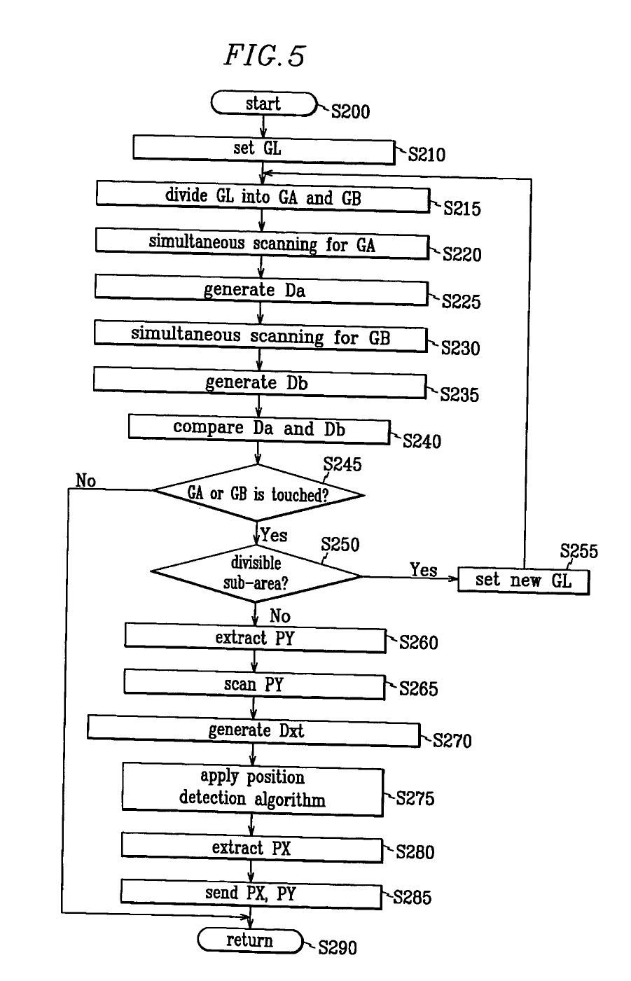

FIG. 4 is a schematic diagram of an exemplary LCD device used to illustrate an exemplary embodiment of a method of detecting a touched position according to the present invention and FIG. 5 is a flow chart of the method thereof.

In the exemplary embodiment of FIG. 5, when an operation starts (S200), the signal controller 600 sets the entire area of the panel assembly 300 to be a sensing area GL (S210), and it divides the sensing area GL into two sensing sub-areas GA and GB (S215). For example, a sensing area GL is divided into a sensing sub-area GA assigned to a set of sensor scanning lines S₁-Sₖ and another sensing sub-area GB assigned to another set of sensor scanning lines Sₖ₊₁-S_{N} as shown in FIG. 4. Here, 1<k<N and k is, for example, equal to about N/2, but other quantities and configurations of sub-groups are also contemplated.

The sensor scanning driver 700 simultaneously makes the voltage levels of sensor scanning signals Vs₁-Vsₖ applied to respective sensor scanning lines S₁-Sₖ in the sensing sub-area GA, equal to the gate-on voltage Von (S220). The switching elements Qs2 in the sensing sub-area GA turn on to output sensor output signals from the sensing elements Qp to the sensor data lines P₁-P_{M}. The sensor output signals entered in each of the sensor data lines P₁-P_{M} join together to form an analog sensor data signal Vp₁-Vp_{M}.

The sensing signal processor 800 receives the analog sensor data signals Vp₁-Vp_{M} from the sensor data lines P₁-P_{M}. The sensing signal processor 800 amplifies and filters the analog sensor data signals Vp₁-Vp_{M}. The sensing signal processor 800 converts the analog sensor data signals Vp₁-Vp_{M} into digital sensor data signals Da(={xa₁-xa_{M}}) (S225) to be sent to the signal controller 600. The digital sensor data signals Da may be, for example, one-dimensional data.

The sensor scanning driver 700 and the sensing signal processor 800 repeats the above-described operations for the sensing sub-area GB. The sensor scanning driver 700 simultaneously scans the sensor scanning lines Sₖ₊₁-S_{N} in the sensing sub-area GB with the sensor scanning signals Vsₖ₊₁-Vs_{N} (S230), and the sensing signal processor 800 generates and outputs digital sensor data signals Db(={xb₁-xb_{M}}) to the signal controller 600 (S235).

In the exemplary embodiment illustrated in FIG. 5, the signal controller 600 compares the digital sensor data signals, Da and Db, (S240) to determine whether any of the two sensing sub-areas GA and GB is touched (S245). The digital sensor data signals Da or Db in an untouched sub-area GA or GB may have almost the same signal level, while some of the digital sensor data signals Da or Db in a touched sub-area GA or GB may have signal levels different from those in the other sub-area GB or GA. Accordingly, the comparison may give a determination of a touched sub-area. In alternative embodiments, a position detection algorithm may be employed to the digital sensor data signals Da and Db for determining whether a sub-area is touched.

The process restarts (S290) when it is determined that no touch exists.

In an exemplary embodiment, the signal controller 600 restarts the process (S290) when it is determined that any of the sub-areas GA and GB is not touched. In other embodiments, a number of sub-areas or a particular sub-area not being touched may restart the process.

In FIG. 5, when it is determined that one of the sub-areas GA and GB is touched, the signal controller 600 determines whether the touched sub-area GA or GB is divisible (S250). In alternative embodiments, the determination that a number of sub-areas or a particular sub-area is touched may initiate the signal controller 600 to determine whether a sub-area is divisible.

When it is determined, in FIG. 5, that the touched sub-area GA or GB is divisible, the signal controller 600 sets the touched sub-area to be a new sensing area GL (S255) and repeats the steps S215 to S250.

In FIG. 5, when it is determined that the touched sub-area GA or GB is indivisible, the signal controller 600 extracts the y-coordinate PY of the touched sub-area GA or GB (S260).

The y-coordinate PY may be obtained by repeating the steps S215 to S250 a predetermined number of times. For example, if the number of the sensor scanning lines S₁-S_{N} is equal to 1024, the predetermined number is equal to ten since 2¹⁰=1024. In alternative embodiments, the number of times steps S215 to S250 is repeated may be defined based on different logic, or the number of times may be indeterminate as being based on still other criteria.

The sensor scanning driver 700 applies a sensor scanning signal Vsy to a sensor scanning line Sy corresponding to the resultant y-coordinate PY (S265).

In the exemplary embodiment of FIG. 5, the sensing signal processor 800 receives the analog sensor data signals Vp₁-Vp_{M} and amplifies and filters the analog sensor data signals Vp₁-Vp_{M}. The sensing signal processor 800 converts the analog sensor data signals Vp₁-Vp_{M} into one-dimensional, digital sensor data signals Dxt (={xt₁-xt_{M}}) (S270) sent to the signal controller 600.

The signal controller 600 receives the digital sensor data signals Dxt and applies a one-dimensional position detection algorithm to the digital sensor data signals Dxt (S275) to extract an x-coordinate PX of the touched position (S280).

The signal controller 600 may send the extracted x and y coordinates, PX and PY respectively, to an external device (S285) and restarts the process (S290).

As described in the exemplary embodiment above, the y-coordinate of the touched position is firstly detected by area division and the x-coordinate of the touched position is then detected. Advantageously, an one-dimensional position detection algorithm may be employed, effectively reducing the amount of data and the process time of the data.

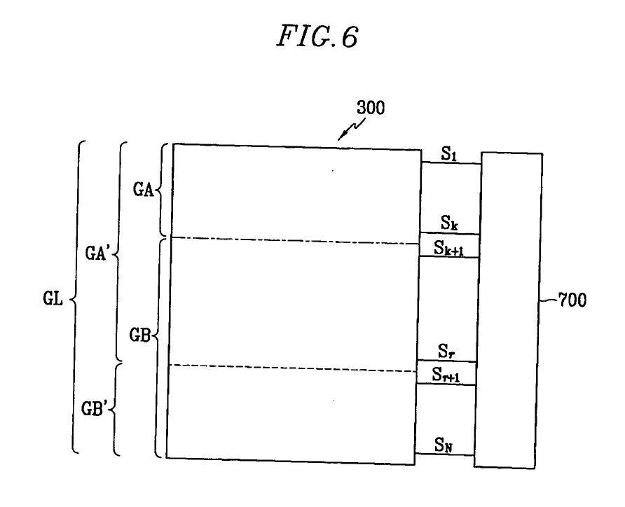

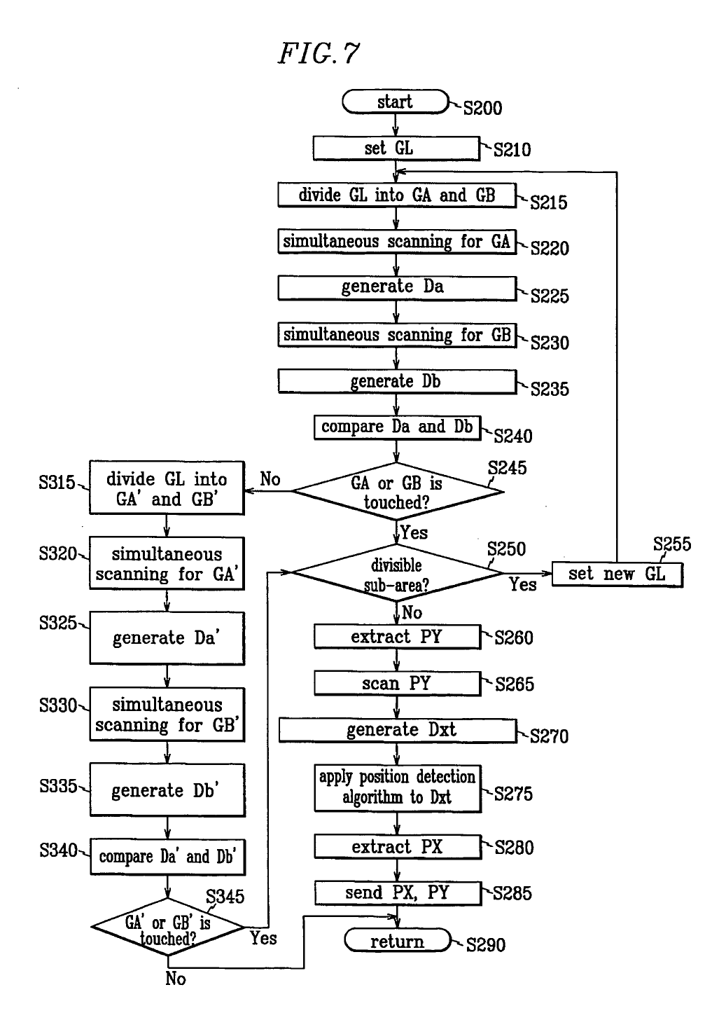

FIG. 6 is a schematic diagram of an exemplary LCD device illustrating another exemplary embodiment of a method of detecting a touched position according to the present invention and FIG. 7 is a flow chart of the method thereof.

In the exemplary embodiment of FIG. 7, when an operation starts (S200), the signal controller 600 performs the steps S210 to S240. Steps S210 through S240 are the same as described above with reference to FIGS. 4 and 5.

The signal controller 600 determines whether any of two sensing sub-areas GA and GB divided from a sensing area GL is touched (S245). When it is determined that any of the sub-areas GA and GB is not touched, the signal controller 600 divides the sensing area GL into two sensing sub-areas GA′ and GB′ that are different from the former sub-areas GA and GB. For example, a sensing area GL is divided into a sensing sub-area GA′ assigned to a set of sensor scanning lines S₁-Sᵣ and another sensing sub-area GB′ assigned to another set of sensor scanning lines Sᵣ₊₁-S_{N} as shown in FIG. 6. Here, 1<r<N and r is different from k described above for FIGS. 4 and 5. Of course, any of a number of quantities and configurations of sub-groups are contemplated.

The sensor scanning driver 700 simultaneously makes the voltage levels of sensor scanning signals Vs₁-Vsᵣ applied to respective sensor scanning lines S₁-Sᵣ in the sensing sub-area GA′, equal to the gate-on voltage Von (S320). The switching elements Qs2 in the sensing sub-area GA′ turn on to output sensor output signals from the sensing elements Qp to the sensor data lines P₁-P_{M}. The sensor output signals entered in each of the sensor data lines P₁-P_{M} join together to form an analog sensor data signal Vp₁-Vp_{M}.

The sensing signal processor 800 receives the analog sensor data signals Vp₁-Vp_{M} from the sensor data lines P₁-P_{M} and it amplifies and filters the analog sensor data signals Vp₁-Vp_{M}. The sensing signal processor 800 converts the analog sensor data signals Vp₁-Vp_{M} into one-dimensional, digital sensor data signals Da′ (={xa₁′-xa_{M}′}) (S325) to be sent to the signal controller 600.

The sensor scanning driver 700 and the sensing signal processor 800 repeats the above-described operations for the sensing sub-area GB′. The sensor scanning driver 700 simultaneously scans the sensor scanning lines Sᵣ₊₁-S_{N} in the sensing sub-area GB′ with the sensor scanning signals Vsᵣ₊₁-Vs_{N} (S330). The sensing signal processor 800 generates and outputs digital sensor data signals Db′ (={xb₁′-xb_{M}′}) to the signal controller 600 (S335).

The signal controller 600 compares the digital sensor data signals Da′ and Db′ (S340) to determine whether any of the two sensing sub-areas GA′ and GB′ is touched (S345).

The signal controller 600 restarts the process (S290) when it is determined that any of the sub-areas GA′ and GB′ is not touched. In other embodiments, a number of sub-areas or a particular sub-area not being touched may restart the process.

In the exemplary embodiment of FIG. 7, when it is determined that one of the sub-areas GA′ and GB′ is touched, the signal controller 600 determines whether the touched sub-area GA′ or GB′ is divisible (S250). In alternative embodiments, the determination that a number of sub-areas or a particular sub-area is touched may initiate the signal controller 600 to determine whether a sub-area is divisible.

Successively, the signal controller 600 performs the steps S250 to S290 as described above with reference to the exemplary embodiments of FIGS. 4 and 5.

As described in the exemplary embodiment above, a touch exerted on a boundary of the sub-areas can be also detected to advantageously improve the reliability of the touch determination.

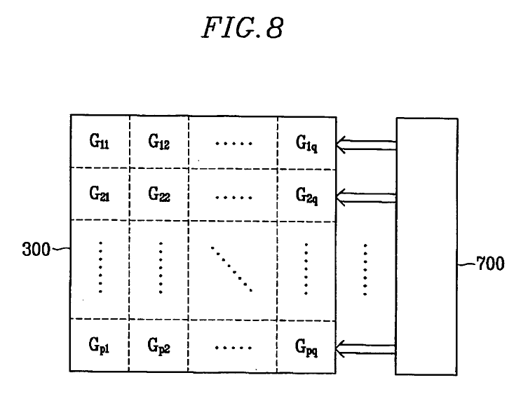

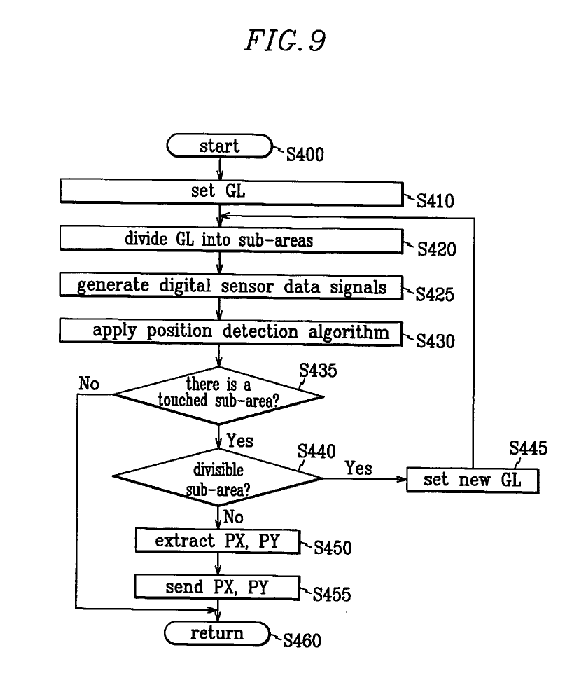

FIG. 8 is a schematic diagram of an exemplary LCD device for used to illustrate another exemplary embodiment of a method of detecting a touched position according to the present invention and FIG. 9 is a flow chart of the method thereof.

When an operation starts (S400), the signal controller 600 sets the entire area of the panel assembly 300 to be a sensing area GL (S410), and it divides the sensing area GL into a plurality of sensing sub-areas (S420). In the exemplary embodiment of FIG. 9, for example, a sensing area GL is divided into p×q rectangular sensing sub-areas G₁₁, G₁₂, . . . , G_{1q}, G₂₁, . . . , G_{pq}. Rows are indexed by ‘p’ and columns by ‘q’. Each of the sub-areas G₁₁-G_{pq} is assigned to a set of sensor scanning lines and sensor data lines as shown in the exemplary LCD device illustrated in FIG. 8. Here, 1<p<N and 1<q<M.

The sensor scanning driver 700 simultaneously makes the voltage levels of sensor scanning signals for the sensing sub-areas G₁₁, G₁₂, . . . , G_{1q} equal to the gate-on voltage Von. The switching elements Qs2 in the sensing sub-areas G₁₁, G₁₂, . . . , G_{1q} turn on to output sensor output signals from the sensing elements Qp to the sensor data lines P₁-P_{M}. The sensor output signals entered in each of the sensor data lines P₁-P_{M} join together to form an analog sensor data signal Vp₁-Vp_{M}.

In the embodiment of FIG. 9, the sensing signal processor 800 receives the analog sensor data signals Vp₁-Vp_{M} from the sensor data lines P₁-P_{M} and it amplifies and filters the analog sensor data signals Vp₁-Vp_{M}. The sensing signal processor 800 converts the analog sensor data signals Vp₁-Vp_{M} into digital sensor data signals x₁-x_{M} sent to the signal controller 600 (S425).

The signal controller 600 adds the digital sensor data signals x₁-x_{M} in each of the sensing sub-areas G₁₁, G₁₂, . . . , G_{1q} to generate an added digital sensor data signal D₁₁, D₁₂, . . . , D_{1q}.

The repetition of the above-described steps yields p×q added digital sensor data signals D₁₁, D₁₂, . . . , D_{1q}, which are represented as a two-dimensional matrix:

$$[ \begin{matrix}{D}_{11} & {D}_{12} & … & {D}_{1 q} \\ {D}_{21} & {D}_{22} & … & {D}_{2 q} \\ … & … & … & … \\ {D}_{p1} & {D}_{p2} & … & {D}_{pq}\end{matrix} ]$$

In the exemplary embodiment of FIG. 9, the signal controller 600 applies a position detection algorithm to the digital sensor data signals (S430) to determine whether any of the sub-areas G₁₁-G_{pq} is touched (S435). The position detection algorithm used in this step may be one-dimensional. In alternative embodiments, the position detection algorithm may also be two-dimensional.

The signal controller 600 restarts the process (S460) when it is determined that any of the sub-areas GA and GB is not touched. In other embodiments, a number of sub-areas or a particular sub-area not being touched may restart the process.

When it is determined that one of the sub-areas G₁₁-G_{pq} is touched, the signal controller 600 determines whether the touched sub-area G₁₁-G_{pq} is divisible (S440). In alternative embodiments, the determination that a number of sub-areas or a particular sub-area is touched may initiate the signal controller 600 to determine whether a sub-area is divisible. When it is determined that the touched sub-area G₁₁-G_{pq} is divisible, the signal controller 600 sets the touched sub-area to be a new sensing area GL (S445) and repeats the steps S420 to S440. The new sensing area may be divided into any of a number of sub-areas, including, but not limited to, p×q sub-areas.

When it is determined that the touched sub-area G₁₁-G_{pq} is indivisible, the signal controller 600 extracts x and y coordinates PX and PY of the touched sub-area G₁₁-G_{pq} (S450).

The signal controller 600 may send the extracted x and y coordinates PX and PY to an external device (S455) and restarts the process (S460).

As described in the exemplary embodiment above, the x and y coordinates of the touched position are simultaneously detected by area division. Advantageously, an one-dimensional position detection algorithm may be employed, effectively reducing the amount of data and the process time of the data.

In the above-described exemplary embodiments, the sensing signal processing repeats in a period of one frame or more.

The above-described exemplary methods may be employed to other display devices including, but not limited to organic light emitting diode (OLED) display, plasma display panel (PDP), and the like.

Without using the sensing elements integrated in the display panel as described above for alternative embodiments, a touch screen panel may be attached to the display panel.

The sensing elements may sense other physical characteristics including, but not limited to, pressure, light, and the like, or any combination of the foregoing. In alternative embodiments, other sensing elements that can sense other physical characteristics than light may be additionally provided at the display panel.

Although exemplary embodiments of the present invention have been described in detail hereinabove, it should be clearly understood that many variations and/or modifications of the basic inventive concepts herein taught, which may appear to those skilled in the present art, will still fall within the spirit and scope of the present invention, as defined in the appended claims.

What is claimed is:

1. A method of detecting a two-dimensional position of a touch, the touch represented by a first and a second coordinate and exerted on an information display panel including a plurality of sensing elements, the method comprising:
determining a range for the first coordinate of the two-dimensional position by driving a first group of the sensing elements; and
determining the second coordinate of the two-dimensional position by driving a second group of the sensing elements, the second group of the sensing elements being included in the first group of the sensing elements.

2. The method of claim 1, wherein the range for the first coordinate is equivalent to the first coordinate.

3. The method of claim 2, wherein the driving of the first group of the sensing elements comprises simultaneously driving the first group of the sensing elements.

4. The method of claim 3, wherein the second group of the sensing elements is equivalent to the first group of the sensing elements.

5. The method of claim 4, wherein the driving of the second group of the sensing elements comprises sequentially driving the second group of the sensing elements.

6. The method of claim 1, wherein the range for the first coordinate is wider than the first coordinate.

7. The method of claim 6, further comprising determining the first coordinate from the range for the first coordinate.

8. The method of claim 7, wherein the first group of the sensing elements further comprises a third group of the sensing elements and a fourth group of the sensing elements, the determination of the range for the first coordinate further comprising:
simultaneously driving the third group of the sensing elements to obtain first sensing data;
simultaneously driving the fourth group of the sensing elements to obtain second sensing data; and
comparing the first sensing data and the second sensing data to determine the range for the first coordinate.

9. The method of claim 8, wherein the first group of the sensing elements further comprises a fifth group of the sensing elements and a sixth group of the sensing elements, the fifth and the sixth groups comprising parts of the sensing elements in the third and the fourth groups, the determination of the range for the first coordinate further comprising:
simultaneously driving the fifth group of the sensing elements to obtain third sensing data;
simultaneously driving the sixth group of the sensing elements to obtain fourth sensing data; and
comparing the third sensing data and the fourth sensing data to determine the range for the first coordinate.

10. The method of claim 7, wherein the determination of the first coordinate comprises reducing the range for the first coordinate by repeatedly driving a reduced number of the first group of the sensing elements.

11. The method of claim 1, wherein the sensing elements generate output signals in response to an incident light.

12. The method of claim 1, wherein the sensing elements generate output signals in response to pressure applied on the display panel.

13. The method of claim 1, wherein the information display panel is selected from a liquid crystal display, an organic light emitting diode display, and a plasma display panel.

14. A method of detecting a two-dimensional position of a touch exerted on an information display panel including a plurality of sensing elements, the method comprising:
determining a range of a first coordinate and a range of a second coordinate by driving a first number of the sensing elements; and
determining the first and the second coordinates by driving a second number of the sensing elements, the second number being less than the first number.

15. The method of claim 14, wherein the determination of the first and the second coordinates comprises reducing the ranges for the first and the second coordinates by repeatedly driving a reduced number of the first number of the sensing elements.

16. A method of driving a display device, the display device including a display panel for detecting a touched position on the display panel, the display panel including a plurality of scanning lines, a plurality of data lines, and a plurality of sensing units coupled to the scanning lines and the data lines, the method comprising:
simultaneously applying scanning signals to the scanning lines;
generating first one-dimensional digital data based on output signals of the sensing units;
extracting an x-coordinate of the touched position by applying a position detection algorithm to the first digital data;
sequentially applying scanning signals to the scanning lines;
reading sensing data signals from one of the data lines corresponding to the x-coordinate the data lines;
generating second one-dimensional digital data based on the sensing data signals; and
extracting a y-coordinate of the touched position by applying a position detection algorithm to the second digital data.

17. The method of claim 16, wherein the simultaneous application applies all the scanning lines in the display panel.

18. The method of claim 17, wherein the extraction of the x-coordinate comprises:
determining whether a touch exists; and
extracting the x-coordinate when it is determined that a touch exists.

19. A method of driving a display device, the display device including a display panel for detecting a touched position on the display panel, the display panel including a plurality of scanning lines, a plurality of data lines, and a plurality of sensing units coupled to the scanning lines and the data lines, the method comprising:
setting an entire area of the display panel as a sensing area;
dividing the sensing area into a first sub-area and a second sub-area, the first sub-area and the second sub-area assigned to different scanning lines;
determining whether any one of the first and the second sub-areas is touched;
extracting a y-coordinate of the touched position in the first sub-area when it is determined that the first sub-area is touched; and
extracting an x-coordinate of the touched position by applying a scanning signal to a scanning line corresponding to the y-coordinate.

20. The method of claim 19, wherein the extraction of the y-coordinate comprises:
determining whether the first sub-area is divisible when it is determined that the first sub-area is touched;
setting the first sub-area as a new sensing area to be divided into new first and second sub-areas when it is determined that the first sub-area is divisible; and
extracting a y-coordinate of the first sub-area as the y-coordinate of the touched position when it is determined that the first sub-area is indivisible.

21. The method of claim 20, wherein the first sub-area and the second sub-area are substantially equivalent halves of the sensing area.

22. The method of claim 20, wherein the determination of whether any one of the first and the second sub-areas is touched comprises:
scanning the first sub-area to receive output signals from the sensing units in the first sub-area;
generating first one-dimensional digital data based on the output signals of the sensing units in the first sub-area;
scanning the second sub-area to receive output signals from the sensing units in the second sub-area;
generating second one-dimensional digital data based on the output signals of the sensing units in the second sub-area; and
comparing the first digital data and the second digital data to determine whether any one of the first and the second sub-areas is touched.

23. The method of claim 22, wherein the extraction of the x-coordinate comprises:
applying a scanning signal to a scanning line corresponding to the y-coordinate;
generating third one-dimensional digital data based on output signals from the sensing units coupled to the scanning line; and
applying a position detection algorithm to the third digital data to extract the x-coordinate of the touched position.

24. The method of claim 23, further comprising:
dividing the sensing area into a third sub-area and a fourth sub-area different from the first and second sub-areas and assigned to different scanning lines when it is determined that none of the first and the second sub-areas is touched;
determining whether any one of the third sub-area and the fourth sub-area is touched; and
extracting a y-coordinate of the touched position in the third sub-area when it is determined that the third sub-area is touched.

25. The method of claim 24, wherein the determination of whether any one of the third sub-area and the fourth sub-area is touched comprises:
scanning the third sub-area to receive output signals from the sensing units in the third sub-area;
generating third one-dimensional digital data based on the output signals of the sensing units in the third sub-area;
scanning the fourth sub-area to receive output signals from the sensing units in the fourth sub-area;
generating fourth one-dimensional digital data based on the output signals of the sensing units in the fourth sub-area; and
comparing the third digital data and the fourth digital data to determine whether any one of the third and the fourth sub-areas is touched.

26. A method of driving a display device, the display device including a display panel for detecting a touched position on the display panel, the display panel including a plurality of scanning lines, a plurality of data lines, and a plurality of sensing units coupled to the scanning lines and the data lines, the method comprising:
setting an entire area of the display panel as a sensing area;
dividing the sensing area into a plurality of sub-areas assigned to different scanning lines and different data lines;
determining whether any one of the sub-areas is touched; and
extracting x and y coordinates of the touched position in a sub-area when it is determined that the sub-area is touched.

27. The method of claim 26, wherein the extraction of the x and y coordinates comprises:
determining whether the sub-area is divisible when it is determined that the sub-area is touched;
setting the sub-area as a new sensing area to be divided into a plurality of new sub-areas when it is determined that the sub-area is divisible; and
extracting x and y coordinates of the sub-area as the x and y coordinates of the touched position when it is determined that the sub-area is indivisible.

28. The method of claim 26, wherein the sub-areas are arranged in a matrix.

29. The method of claim 26, wherein the determination of whether any one of the sub-areas is touched comprises:
scanning each of the sub-areas to receive output signals from the sensing units in the sub-areas;
generating a digital data for each of the sub-areas based on the output signals of the sensing units in the sub-areas; and
applying a position detection algorithm to the digital data to determine whether any one of the sub-areas is touched.

30. A display device comprising:
a display panel including a plurality of scanning lines, a plurality of data lines, a plurality of sensing units coupled to the scanning lines and the data lines; and
a detection unit detecting a two-dimensional position of a touch exerted on the display panel and represented by first and second coordinates,
wherein the detection unit determines a range for the first coordinate of the two-dimensional position by applying scanning signals to a first group of the scanning lines, and determines the second coordinate of the two-dimensional position by applying scanning signals to a second group of the scanning lines, the second group of the scanning lines being included in the first group of the scanning lines.

31. The display device of claim 30, wherein the detection unit comprises:
a scanning driver applying scanning signals simultaneously to at least two of the scanning lines;
a sensing signal processor generating digital data based on output signals from the sensing units; and
a signal controller dividing the display panel into a plurality of sub-areas and determining the first and second coordinates based on the digital data for the sub-areas.

32. The display device of claim 30, wherein the detection unit includes one of an integrated single chip, a flexible printed circuit in a tape carrier package, and combination at least one of the foregoing.

33. The display device of claim 30, wherein the sensing units generate the output signals in response to one of incident light, pressure and any combination including at least one of the foregoing.

34. The display device of claim 30, wherein the display device is selected from a liquid crystal display, an organic light emitting diode display, and a plasma display panel.
